(19) United States
(12) Patent Application Publication
(10) Pub. No.: US 2009/0166366 A1
(43) Pub. Date: Jul. 2, 2009

(54) Container having handling hole for transportation and opening and closing member for handling hole and manufacturing method for the same

(75) Inventors: Shinji Kaneko, Toyoake (JP); Tatsuya Tamura, Miura (JP); Ryozo Kuwata, Nagoya (JP)

Correspondence Address: OLIFF & BERRIDGE, PLC, P.O. BOX 320850, ALEXANDRIA, VA, 22320-4850, US

(73) Assignees: Tokai Kogyo Company Limited, Obu-City (JP); Taiyo-Shizai Limited Partnership Corporation, Nagoya-city (JP)

(21) Appl. No.: 12/318,328

(22) Filed: Dec. 24, 2008

(30) Foreign Application Priority Data
Dec. 27, 2007 (JP) 2007-335645

(51) Int. Cl. B65D 90/02; B31B 1/14

(52) U.S. Cl. 220/676; 493/56

(57) ABSTRACT

A main body of an opening and closing member is arranged so as to cover a handling hole from one side of a wall, such as a container wall. The opening and closing member is mounted to the container by engaging an engagement portion with a flange formed at the periphery of the handling hole. When a user inserts a hand into the handling hole and pushes the main body, the main body moves away from the wall, and the handling hole is uncovered. By so doing, the user can insert his or her hand into the handling hole and carry the container or other object. Then, when the user removes his or her hand from the handling hole, the main body moves toward the wall, and an outer periphery of the main body contacts the wall at the periphery of the handling hole and returns to the original position. Thus, the handling hole is covered from one side of the wall. By so doing, dirt, water and/or the like can be suppressed from passing through the handling hole. Thus, the container or other object can easily be carried by using the handling hole, and dirt, water and/or the like can be suppressed from passing through the handling hole without requiring a special operation or task.

### BACKGROUND

This invention relates to containers or other objects having a wall in which a handling hole, a handling hole opening and closing member mounted to such walls, and methods for manufacturing the opening and closing member.

Conventionally, in order to easily carry a container, in a box-shaped container which contains, carries, and/or stores an article, etc. inside, handling holes are formed respectively in a pair of side walls opposite to each other. The user inserts his hands (for example, four fingers other than the thumb) into these handling holes and can carry the container.

As described in, for example, Japanese Published Patent Application 2001-18979 (JP-A-2001-18979), as a container in which such handling holes are formed, on a pair of opposing side walls of a cardboard box (container), the respective handling pieces are formed by a die-cutting process so as to be foldable, and gripping holes (handling holes) are formed in the respective side walls of the cardboard box by folding the handling pieces to the inside of the cardboard box.

### SUMMARY

However, when a plurality of containers in which the handling holes are formed contain an article or the like and are carried or stored in a stacked state, an object such as sand, dust, water drops, etc. may enter the container through the handling holes from the outside. If this type of object attaches to the article contained in the container, there is a possibility that article quality might deteriorate. For example, when an object such as sand or dust attaches to an article surface, there is a possibility that the article surface will be contaminated, and scratches may be generated on the article surface by vibration. Furthermore, when water drops attach to the article surface, there is a possibility that changes in a performance capability and/or rust might be generated due to water absorption.

As a countermeasure, an adhesive tape may be attached so as to seal the handling holes after the container is carried. However, this method is extremely troublesome because adhesive tape needs to be attached after the container is carried, and the adhesive tape needs to be removed when the contained is again carried.

This invention was made in consideration of these situations. Therefore, an object of various embodiments of this invention is to easily carry a container or other object by using one or more handling holes, and to suppress undesired objects from passing through the handling holes without performing a special operation.

In order to accomplish the above-mentioned objects, various embodiments provide an assembly comprising a wall in which a handling hole is formed; a flange protruding outward from a periphery of the handling hole; an opening and closing member including a main body with an external dimension that is larger than at least one of a horizontal direction dimension or a vertical direction dimension of the handling hole; a projection portion protruding from an edge of the main body, the projection portion being sized to fit through the handling hole; and an engagement portion, which engages the flange, and which extends from the projection portion, the engagement portion and a coupling portion that connects the main body and the projection portion being formed from an elastically deformable material. The opening and closing member is arranged such that the main body covers the handling hole from one side of the wall, and the opening and closing member is mounted to the wall by engagement of the engagement portion with the flange. When an external force acts on the main body through the handling hole, the main body moves and the handling hole is uncovered. When the external force is released, the main body elastically recovers and moves toward the wall, and part of the main body contacts the wall at the periphery of the handling hole so as to cover the handling hole. Various embodiments provide the above-described opening and closing member alone, for installation into an assembly as described above.

With this structure, by engaging the engagement portion of the opening and closing member with the flange formed at the periphery of the handling hole of the wall, the opening and closing member is mounted to the wall. Thus, the opening and closing member can be easily mounted without adding special changes in shape, hole openings, or the like to the already-existing wall (the wall in which the flange is formed at the periphery of the handling hole), adding changes into a manufacturing device used to make the object that includes the wall, or manufacturing a new device. Also, when the opening and closing member is not needed, the opening and closing member can be easily removed.

Furthermore, if a user inserts his or her hand into the handling hole, the main body of the opening and closing member is pushed, and the handling hole is uncovered. Thus, the user can insert his hand into the handling hole and can hold the object, and the object (e.g., container or other object) can be easily carried. Then, when the user removes his or her hand from the handling hole, the main body of the opening and closing member returns to the original position, and the handling hole is closed. Thus, without performing a special operation or task, an object (sand, dust, water drops, etc.) can be suppressed from passing through the handling hole during e.g., storage or transportation, and quality of an article, etc. protected by the wall can be ensured.

Additionally, by closing the handling hole with the main body of the opening and closing member, even if an article is stored above the position of the handling hole, the article can be suppressed from falling through the handling hole. Thus, the article can be stored at a position higher than the handling hole. By so doing, for example, the storage capacity of a container can be increased compared to that of a conventional container, and storage and transportation spaces can be reduced.

The engagement portion of the opening and closing member may be engaged with an upper edge flange portion formed along the upper edge of the handling hole, and the main body of the opening and closing member may move by rotating about the upper edge. Thus, by using the upper edge flange portion which reinforces the upper edge of the handling hole, the opening and closing member can be simply mounted.

Alternatively, the engagement portion of the opening and closing member may be engaged with a lower edge flange portion formed along the lower edge of the handling hole, and the main body of the opening and closing member may move by rotating about the upper edge. Thus, by using the lower edge flange portion which reinforces the lower edge of the handling hole, the opening and closing member can be simply mounted.

Alternatively, the engagement portion of the opening and closing member may be engaged with a side edge flange portion formed along a side edge of the handling hole, and a main body of the opening and closing member may move by rotating about the side edge. Thus, by using the side edge flange portion which reinforces the side edge of the handling hole, the opening and closing member can be simply mounted.

The projection portion may be arranged so as to protrude outward from the upper or lower edge of the main body, and the engagement portion may be formed in a folded-back shape so as to wrap around the flange. Thus, the engagement portion of the opening and closing member can be securely engaged with the flange.

It is acceptable for an extension portion to be arranged which extends in a direction parallel to the main body from an upper or lower edge of the main body, and the extension portion may be formed so as to contact a surface of the wall that is opposite to a surface from which the flange extends. Thus, the opening and closing member may be mounted so as to sandwich the flange between the extension portion and the engagement portion of the opening and closing member. Therefore, the opening and closing member can be mounted at an accurate position without dislocation toward the outside of the wall, and the engagement portion can be suppressed from falling from the flange.

Furthermore, in the engagement portion, a slit can be formed which can engage a reinforcement rib formed in a direction crossing the flange. Thus, the engagement portion can be engaged with the flange without interfering with the reinforcement rib. Furthermore, position shifting of the opening and closing member in the horizontal direction (horizontal direction of the handling hole) is suppressed.

Furthermore, at least the coupling portion and the engagement portion can be formed from an elastic polymer material which is flexible and provides an elastic recovery force. Thus, the opening and closing member can be easily moved, and the engagement portion can be easily engaged with the flange.

Alternatively, the entire opening and closing member can be formed from the elastic polymer material which is flexible and is provided with an elastic recovery force. Thus, a contact feeling becomes soft when the user inserts his hand into the handling hole and touches the opening and closing member, and manufacturing is easy.

The elastic polymer material may comprise rubber, synthetic resin, or thermoplastic elastomer. These materials are readily available.

Furthermore, a concave groove may be formed in the coupling portion along a base end of the projection portion, such that the coupling portion is thinner at the concave groove than at a portion adjacent to the concave groove. Thus, the portion at which the concave groove is formed in the coupling portion becomes thinner than other portions so as to allow easy bending, so the opening and closing member can be easily opened and operated (moved relative to the wall). Also, deformation of other portions can be suppressed when the opening and closing member is opened and closed (moved).

Furthermore, the projection portion may protrude from the upper edge of the main body, and on the lower surface of the projection portion, a hollow tubular portion can be formed, which extends along the main body. Thus, when the user inserts his or her hand into the handling hole, the contact feeling can be made soft when the user carries the tubular portion.

Furthermore, the tubular portion may be formed in a substantially wave shape in which protrusions and recesses alternate in a direction along the main body. Thus, when the user inserts his or her hand into the handling hole and holds the tubular portion, the fingers engage the recesses, and the user can stably hold the tubular portion.

The main body may be formed at an inclination so that, in a state prior to mounting the opening and closing member to the handling hole, a lower edge of the main body protrudes farther than an upper edge of the main body, in a direction parallel to the projection portion.

When the opening and closing member is manufactured, an elongate opening and closing member continuous body is prepared, which is continuous in a longitudinal direction, and in which a main body, a projection portion protruding from an upper or lower edge of the main body, and an engagement portion which extends from the projection portion, and which engages the flange, are integrally arranged, and in which at least (i) a coupling portion that couples the main body and the projection portion and (ii) the engagement portion are formed from an elastically deformable material. A cutting step is then performed, which simultaneously or sequentially (i) cuts the main body of the opening and closing member continuous body to a predetermined horizontal direction dimension, and (ii) cuts the projection portion and the engagement portion of the opening and closing member continuous body. Additionally, when cutting of the main body and cutting of the projection portion and the engagement portion are sequentially performed, after the main body is cut, the projection portion and the engagement portion can be cut. Alternatively, after the projection portion and the engagement portion are cut, the main body can be cut. Thus, by merely cutting the extruded opening and closing member continuous body, the opening and closing member can be manufactured; thus, the opening and closing member can be easily manufactured at a low cost.

As a continuous body preparation step, an extruding step can be performed, which extrudes the opening and closing member continuous body in a constant horizontal cross-section shape from a polymer material. Thus, the opening and closing member continuous body can be continuously manufactured efficiently and simply.

Additionally, in the extruding step, at least the coupling portion and the engagement portion can be molded from an elastically deformable polymer material. Even when the coupling portion and the engagement portion are partially molded from an elastically deformable polymer material, the opening and closing member continuous body can be simply molded by extruding different types of polymer material.

Furthermore, in the extruding step, the entire opening and closing member continuous body can be molded from an elastically deformable polymer material of which a hardness is smaller than that of a material of the wall. Thus, the entire opening and closing member continuous body can be more simply molded by ordinary extruding of one type of polymer material.

In addition, in the extruding step, a hollow tubular portion can be integrally molded, which extends continuously in a longitudinal direction at a lower surface of the projection portion. Thus, the tubular portion can be simply molded by extruding.

Furthermore, a pushing roller can be used, in which protrusions and recesses alternate along an outer circumferential portion. A protrusion and recess molding step may be included in which after the extruding step, in a state in which the outer circumferential portion of the pushing roller is pushed against the lower surface of the tubular portion, by rotating the pushing roller in synchronization with an extruding speed, the tubular portion can be molded in a wave shape in which protrusions and recesses alternate along a longitudinal direction. Thus, the tubular portion can be simply molded by a pushing roller in a wave shape.

The pushing roller may be formed so that its outer circumferential length becomes an integer multiple of the horizontal direction dimension of the main body. Thus, the pushing roller molds the tubular portion in a substantially wave shape for a predetermined number of pieces (for example, one piece) of the opening and closing member per rotation.

Additionally, on the pushing roller, at least one protrusion may be formed whose circumferential length is different from that of other protrusions. Thus, in the tubular portion of the opening and closing continuous body, a recess can be molded whose length is different from that of other recesses. This portion can be used as a reference for cutting.

Furthermore, in the extruding step, a ventilation groove may be molded which extends continuously in a longitudinal direction (extruding direction) on the lower surface of the projection portion of the tubular portion, and in the recess and protrusion molding step, the tubular portion can be molded in a wave shape so that the hollow portions of the protrusions of the tubular portions are connected to each other by the ventilation groove. Thus, the hollow portions of the protrusions of the tubular portion can be connected by the ventilation groove, and deformation of the protrusions due to fluctuation of air pressure can be suppressed.

### BRIEF DESCRIPTION OF THE DRAWINGS

Exemplary embodiments are described below with reference to the drawings, in which like numerals represent like parts, and wherein:

FIG. 1 is a front view of a container main body of embodiment 1 of this invention;

FIG. 2 is a plan view of the container main body of embodiment 1;

FIG. 3 is a side view of the container main body of embodiment 1;

FIG. 4 is a view in which a handling hole of the container main body and the peripheral portion of the handling hole of embodiment 1 is seen from outside of the container main body;

FIG. 5 is an A-A cross-sectional view of FIG. 4;

FIG. 6 is a front view of an opening and closing member of embodiment 1;

FIG. 7 is a plan view of the opening and closing member of embodiment 1;

FIG. 8 is a B-B cross-sectional view of FIG. 6;

FIG. 9 is a view in which the opening and closing member mounted to the container main body of embodiment 1, and the peripheral portion of the opening and closing member, are seen from the inside of the container main body;

FIG. 10 is a C-C cross-sectional view of FIG. 9;

FIG. 11 is a side view of an extruder and a pushing device;

FIG. 12 is a D-D cross-sectional view of FIG. 11;

FIG. 13 is a schematic structural view of a cutting device and the surrounding portion;

FIG. 14 is a side view of a container main body of embodiment 2;

FIG. 15 is a plan view of an opening and closing member of embodiment 2;

FIG. 16 is a front view of an opening and closing member of embodiment 3;

FIG. 17 is a plan view of the opening and closing member of embodiment 3;

FIG. 18 is a side view of the opening and closing member of embodiment 3; and

FIG. 19 is a side view of an opening and closing member of embodiment 4.

### DETAILED DESCRIPTION OF EMBODIMENTS

The following explains various exemplary embodiments of the invention.

### Embodiment 1

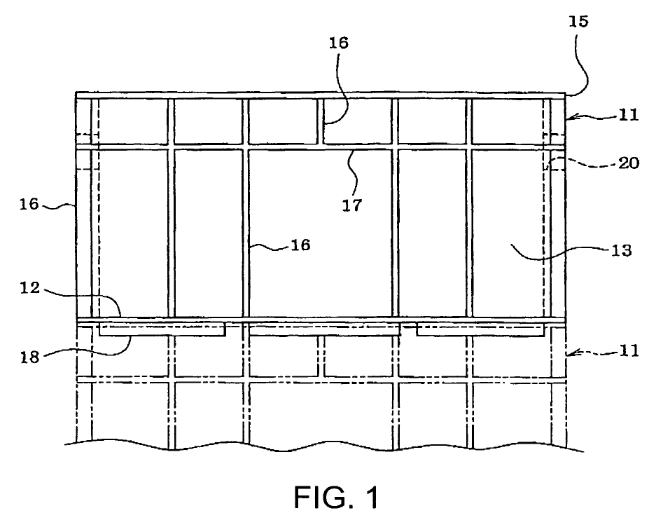

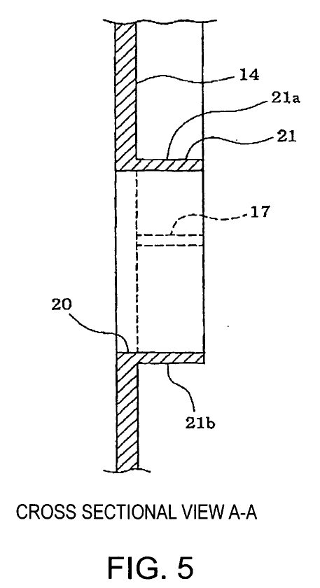

Embodiment 1 of this invention is explained based on FIGS. 1-13.

As shown in FIGS. 1-3, a container main body 11 of a transportable container is formed in a box shape, e.g., by injection molding of a hard synthetic resin such as polypropylene, or another suitable material. The container main body 11 includes a bottom wall 12, a pair of first side walls 13 opposite to each other and sandwiching a short side of the bottom wall 12, and a pair of second side walls 14 opposite to each other and sandwiching a long side of the bottom wall 12.

At an outer periphery of an upper end portion of the container main body 11 (outer periphery of the upper end portion of the respective side walls 13, 14), an upper edge flange 15 is integrally formed. Furthermore, on the outer surface of the respective side walls 13, 14 (including corner portions of the container main body 11), one or a plurality of vertical reinforcement ribs 16 may be integrally formed extending in a vertical direction, and one or a plurality of horizontal reinforcement ribs 17 may be integrally formed extending in a horizontal direction.

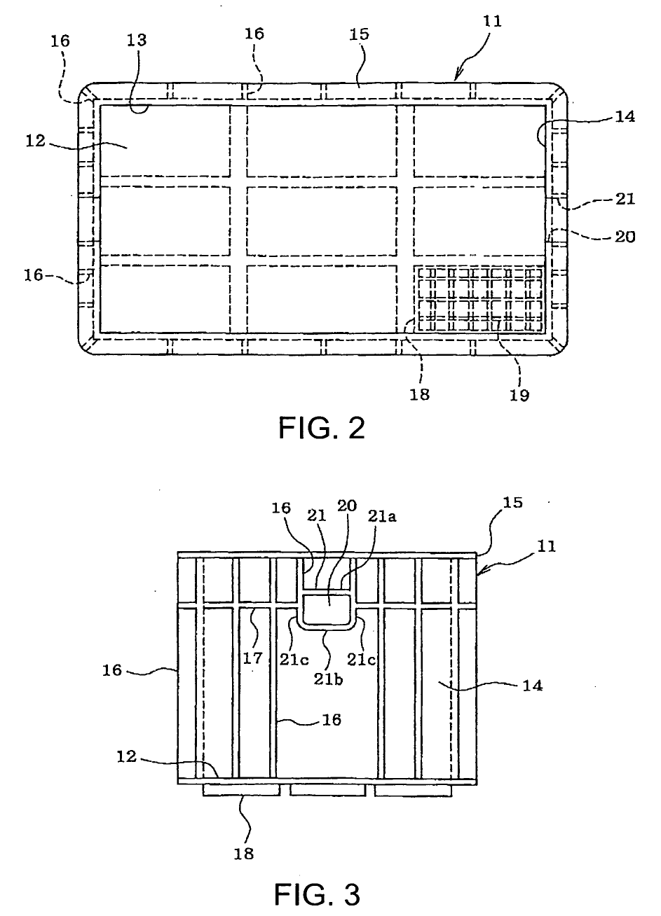

Furthermore, a plurality of positioning projections 18 may be integrally formed on the lower surface of the bottom wall 12. When a plurality of the container main bodies 11 are stacked, the positioning projections 18 of a container main body 11 on an upper side of the stack may be engaged with an opening portion of a container main body 11 (see two-dotted chain lines in FIG. 1) on a lower side of the stack. Each positioning projection 18 may be molded by reinforcing ribs 19 arranged in a checkered pattern (see FIG. 2) or another pattern.

Furthermore, as shown in FIGS. 3-5, handling holes 20 are formed in the upper portion side of a pair of second side walls 14 that are opposite to each other. Along the periphery of each handling hole 20, a flange 21 is integrally formed, protruding outward from the container main body 11 from the respective second side walls 14 in a ring shape corresponding to the shape of the handling holes 20. A user can carry the container main body 11 by inserting a hand (for example, four fingers other than the thumb) into each handling hole 20. Each flange 21 in this example is constituted by an upper edge flange portion 21a formed along the upper edge of the handling hole 20, a lower edge flange portion 21b formed along the lower edge of the handling hole 20, and side edge flange portions 21c, 21c formed along the side edges of the handling hole 20.

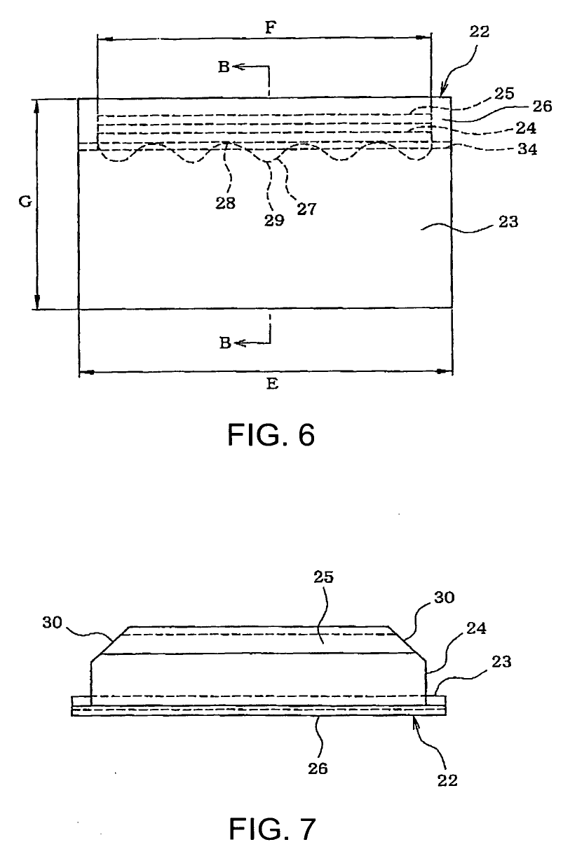

The following explains a structure of an opening and closing member 22 which is mounted so as to seal the handling hole 20 of the container main body 11, with reference to FIGS. 6-10.

As shown in FIGS. 6-8, the opening and closing member 22 is integrally provided with a main body 23 which is formed in a plate shape, preferably a flat plate shape; a projection portion 24 that protrudes toward an outer surface side of the main body 23 (direction crossing the main body 23 at substantially a right angle outside of the side walls 13, 14 of the container main body 11) from the upper edge of the main body 23; an engagement portion 25 engaged with a flange 21 (upper edge flange portion 21a in this embodiment 1) formed at a tip end side of the projection portion 24; and an extension portion 26 that extends in a direction (upward direction) that may be substantially parallel to the main body 23 from the upper edge of the main body 23. Furthermore, on a lower surface of the projection portion 24, a hollow tubular portion 27 is integrally formed, which extends along the main body 23 (e.g., along a horizontal direction of the handling hole 20 of the container main body 11). This tubular portion 27 may be formed as a plurality of (for example, four) recesses 28 and a plurality of (for example, five) protrusions 29 that are formed in a substantially continuous, alternating wave shape in a direction substantially parallel to the main body 23.

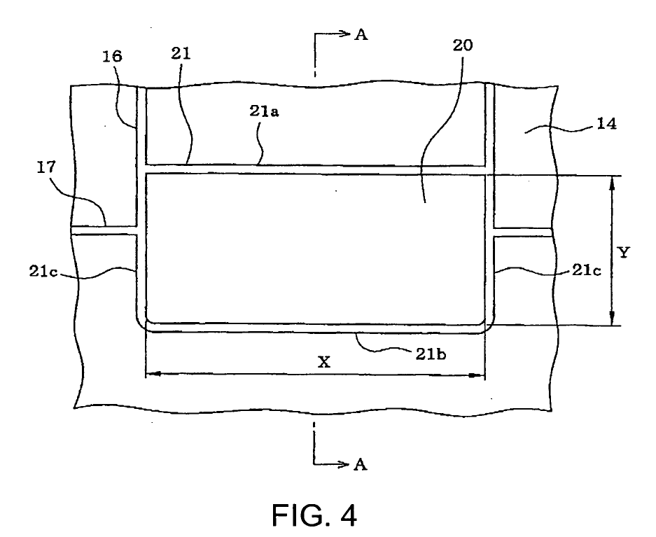

As shown in FIG. 6, the main body 23 is formed in a size in which at least one of a horizontal direction dimension E and a vertical direction dimension G is longer than at least one of a horizontal direction dimension X and a vertical direction dimension Y (see FIG. 4) of the handling hole 20. Furthermore, preferably, if the horizontal direction dimension E and the vertical direction dimension G are formed so as to be longer than the horizontal direction dimension X and the vertical direction dimension Y of the handling hole 20, respectively, the handling hole 20 can be securely sealed. The projection portion 24 and the engagement portion 25 are formed in a horizontal direction dimension F which is not longer than the horizontal direction dimension X of the handling hole 20 (substantially the same or a slightly shorter dimension), and can go through the handling hole 20.

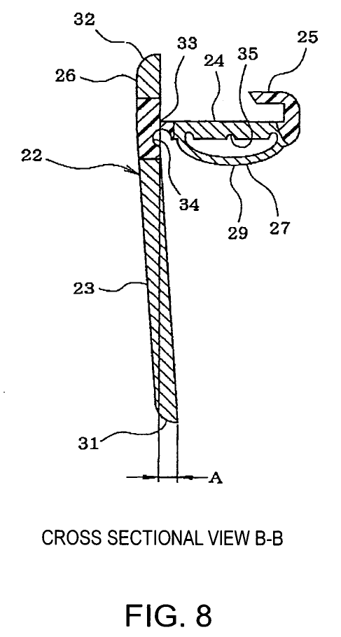

As shown in FIG. 7, both corner portions of the tip end of the projection portion 24 and the engagement portion 25 are chamfered, forming tapered portions 30. As shown in FIG. 8, the respective outer peripheries of the main body 23 and the extension portion 26 may be chamfered, and tapered portions 31 and 32 may be formed so as not to catch on an article that is inserted or removed. Additionally, the engagement portion 25 may be formed in a substantially folded state so as to wrap around and engage the upper edge flange portion 21a, and can be securely engaged to the upper edge flange portion 21a.

As shown in FIG. 8, for the opening and closing member 22, a coupling portion 33 of the main body 23 and the projection portion 24 (a coupling portion 33 that connects a base end portion of the projection portion 24 and the main body 23 in the vicinity of the base end portion), and the engagement portion 25 may be formed of an elastically deformable polymer material. The portions other than the coupling portion 33 and the engagement portion 25 may be formed of another polymer material (polymer material harder than that of the coupling portion 33 and the engagement portion 25). An elastically deformable polymer material which forms the coupling portion 33 and the engagement portion 25 may be an elastic polymer material of which hardness is smaller than that of the material used for the container main body 11 and is flexible, and has an elastic recovery force. For example, readily available materials such as cured rubber, synthetic resin, thermoplastic elastomer, and the like can be used. By forming the coupling portion 33 and the engagement portion 25 from this type of elastic polymer material, the folded-back engagement portion 25 is elastically deformed and expands to wrap around the flange portion, and then closes due to the elastic recovery so as to be easily engaged with the flange 21 (e.g., the upper edge flange portion 21a). Additionally, the opening and closing member 22 is elastically deformed about the coupling portion 33 and can be easily moved so as to be opened and closed.

Furthermore, the main body 23 may be formed at an inclination so that its lower edge protrudes toward the projection portion 24 side (toward the outside of the second side wall 14 of the container main body 11) for a predetermined dimension A with respect to the upper edge of the main body 23. When the opening and closing member 22 is mounted to the container main body 11, the lower edge side of the main body 23 securely contacts the inside of the second side wall 14 of the container main body 11. In the coupling portion 33, a concave groove 34 may be formed, which extends continuously along the base end portion of the projection portion 24. The portion of the coupling portion 33 forming the concave groove 34 is thinner than other adjacent portions, so it can easily be bent at that position. Furthermore, the lower surface of the projection portion 24 of the tubular portion 27 may have a plurality of ventilation grooves 35 extending continuously in a direction substantially parallel to the main body 23 (longitudinal direction), and the hollow portions of each protrusion 29 of the tubular portion 27 may be in communication with each other in a longitudinal direction via the ventilation grooves 35.

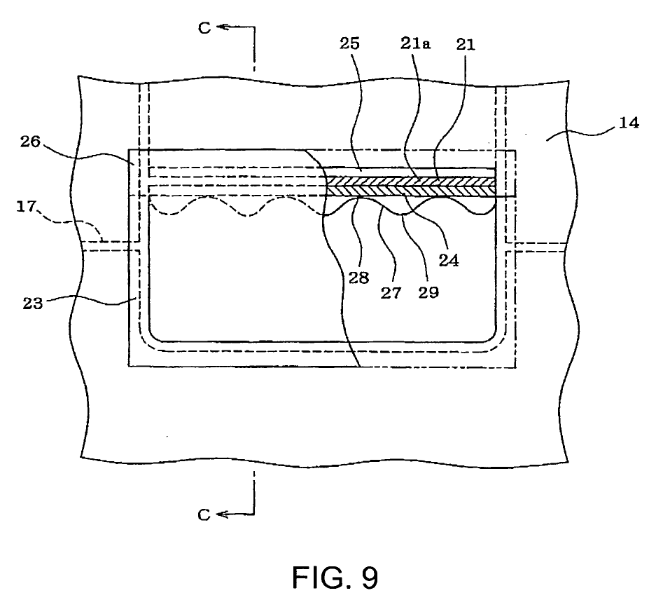

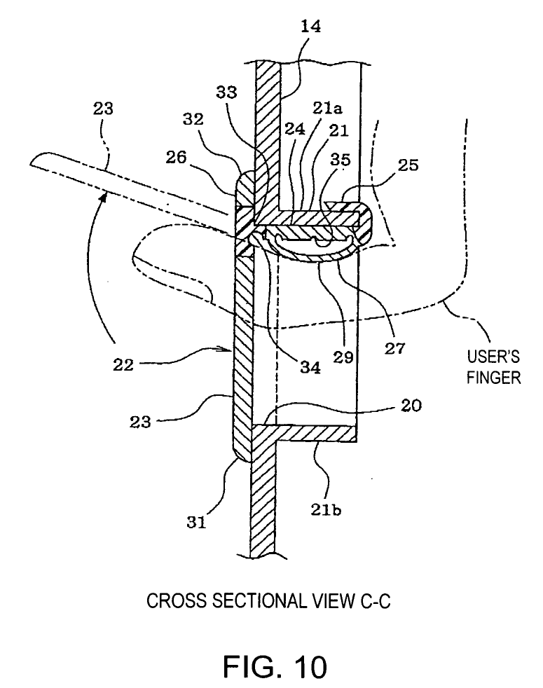

As shown in FIGS. 9 and 10, in a state in which the main body 23 of the opening and closing member 22 is arranged so as to close the handling hole 20 from the inside of the container main body 11, the engagement portion 25 is elastically deformed and expanded, and wrapped around the upper edge flange portion 21a formed along the upper edge of the handling hole 20. The engagement portion 25 closes due to elastic recovery, and engages with the upper edge flange portion 21a. Thus, by using the upper edge flange portion 2 la which enforces the upper edge of the handling hole 20, the opening and closing member 22 can be simply mounted to the container main body 11. At this time, the extension portion 26 contacts the inside of the second side wall 14 on the upper side of the handling hole 20, so the upper edge flange portion 21a can be inserted between the extension portion 26 and the engagement portion 25. Furthermore, when the opening and closing member 20 is removed, a procedure which reverses the above-mentioned order is used to easily remove the opening and closing member 20.

Furthermore, as the user inserts his hand (for example, four fingers other than the thumb) into the handling hole 20 of the container main body 11 and presses the main body 23 of the opening and closing member 22, and thus an external force acts on the main body 23 through the handling hole 20 from the outside of the container main body 11, the handling hole 20 is opened as the main body 23 is elastically deformed and moved, e.g., by rotating about the coupling portion 33 (upper edge side) toward the inside of the container main body 11, as shown in two-dotted chain lines of FIG. 10. By so doing, the user inserts his hand into the handling hole 20 and can carry the container main body 11.

Then, as the user removes his hand from the handling hole 20 of the container main body 11, the external force acting on the opening and closing member 22 is released. At this time, as shown by solid lines in FIG. 10, the main body 23 moves by elastic recovery toward the outside of the container main body 11 about the coupling portion 33, and the outer periphery of the main body 23 returns to the original position and contacts the inside of the second side wall 14 of the periphery of the handling hole 20. Thus, the handling hole 20 is closed from the inside of the container main body 11. By so doing, an undesired object (sand, dust, water drops, etc.) can be suppressed from entering the container main body 11 through the handling hole 20.

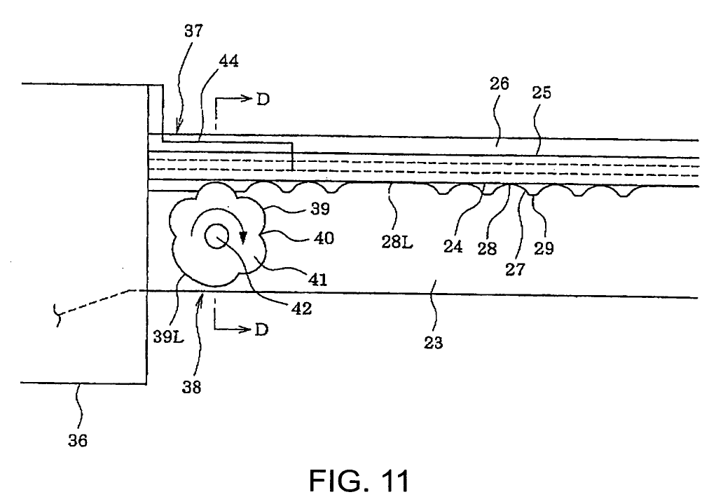

The following explains a method of manufacturing the opening and closing member 22 with reference to FIGS. 11-13.

When the opening and closing member 22 is manufactured, an extrusion molding step (continuous body preparation step) is first performed. In this extrusion molding step, as shown in FIG. 11, an elongate opening and closing member continuous body 37 which is continuous in a longitudinal direction and has a constant horizontal cross-sectional shape is extruded from a polymer material by an extruder 36. In this opening and closing member continuous body 37, the main body 23, the protruding portion 24, the engagement portion 25, the extension portion 26, and the tubular portion 27 are integrally molded together. Inside of the tubular portion 27, the ventilation grooves 35 are molded, which extend continuously in the longitudinal direction on the lower surface of the projection portion 24 of the tubular portion 27. In this embodiment 1, by extrusion molding, the coupling portion 33 and the engagement portion 25 are molded by an elastic polymer material that has a smaller hardness, and more flexibility, than the material of the container main body 11. An elastic recovery force is provided in the material of the coupling portion 33 and the engagement portion 25. Portions other than the coupling portion 33 and the engagement portion 25 are molded by another polymer material (polymer material harder than that of the coupling portion 33 and the engagement portion 25). By so doing, the opening and closing member continuous body 37 can be continuously manufactured efficiently and simply.

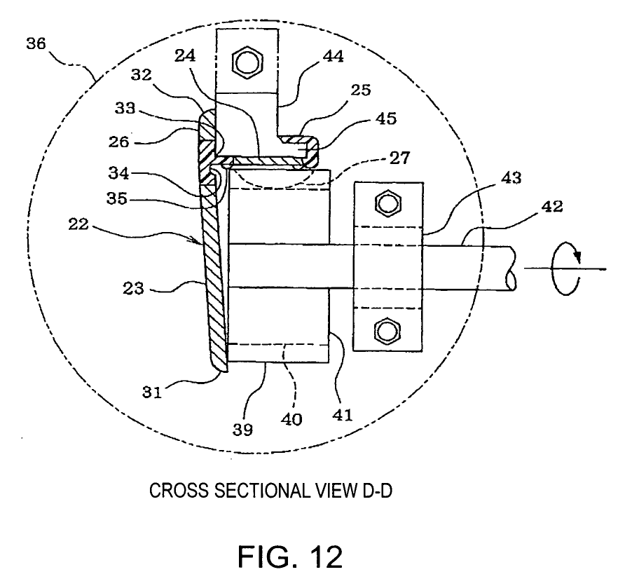

After the extruding molding step is performed, a recess and protrusion molding step is performed. According to this recess and protrusion molding step, as shown in FIGS. 11 and 12, a pushing device 38 is used. In this pushing device 38, a pushing roller 41 is arranged in which protrusions 39 and recesses 40 are formed alternatingly so as to be continuous along the outer peripheral portion, and is rotatably driven by a motor or the like (undepicted) controlled in a state in which a rotational axis 42 of the pushing roller 41 is supported by a bearing 43. Above the pushing roller 41, a support member 44 is arranged, which supports the opening and closing member continuous body 37 which is extruded in a predetermined constant horizontal cross-sectional shape from the extruder 36. By engaging the engagement portion 25 of the opening and closing member continuous body 37 with a projecting support portion 45 formed in a horizontal cross-sectional substantially L shape, this support member 44 is supported in a state in which the opening and closing member continuous body 37 is suspended.

In the recess and protrusion molding step, the pushing roller 41 is rotatingly driven in synchronization with an extruding speed in a state in which the outer circumferential portion of the pushing roller 41 is pushed against the lower surface of the tubular portion 27 when the tubular portion 27 of the opening and closing member continuous body 37 extruded by the extruder 36 is in a plastically deformable state. Thus, the protrusions 39 and the recesses 40 of the pushing roller 41 are pressed against the lower surface of the tubular portion 27, the tubular portion 27 is molded in a substantially wave shape in which the recesses 28 and the protrusions 29 are alternately continuous in a longitudinal direction. By so doing, the tubular portion 27 can be simply molded in a substantially wave shape. At this time, hollow portions within each protrusion 29 of the tubular portion 27 are connected to the ventilation grooves 35 in the longitudinal direction so as to allow air to pass, and the tubular portion 27 is molded in a substantially wave shape.

The pushing roller 41 is formed such that its outer circumferential length is an integer multiple (for example, one time) the horizontal direction dimension E of the main body 23 of the opening and closing member 22. The pushing roller 41 molds the tubular portion 27 in a substantially wave shape for a predetermined number of pieces (for example, one piece) of the opening and closing member 22 per rotation. Furthermore, on the pushing roller 41, one protrusion 39L is formed whose circumferential length is longer than that of the other protrusions 39. By so doing, a recess 28L which is longer than the other recesses 28 is molded in the tubular portion 27 of the opening and closing member continuous body 37, and the portion can be used as a reference for cutting.

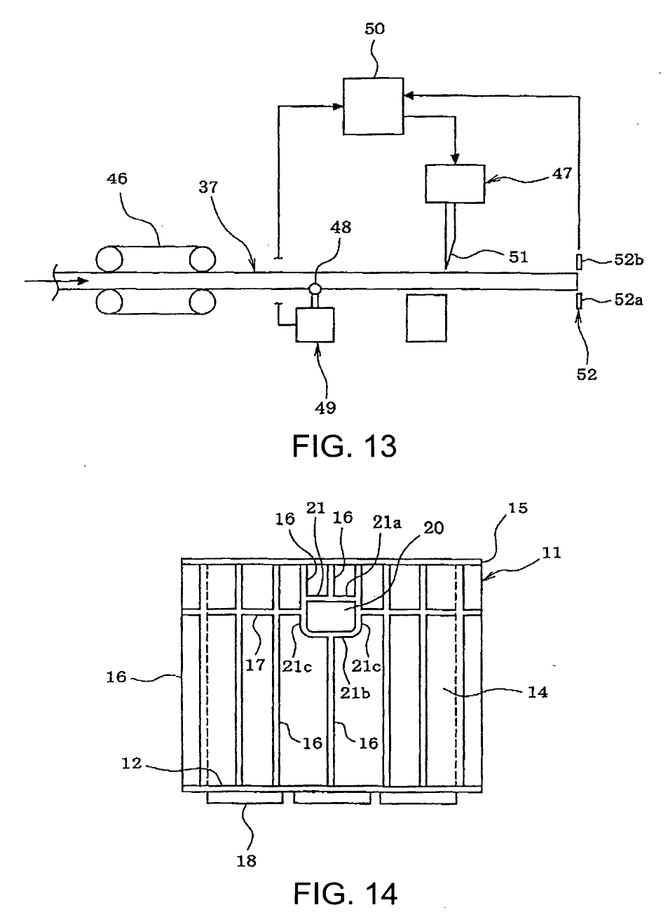

After the recess and protrusion molding step is performed, a cutting step is performed. In this cutting step, as shown in FIG. 13, the opening and closing member continuous body 37 in which the tubular portion 27 is molded in a substantially wave shape is hauled by a hauling machine 46 and is supplied to a cut-off machine 47. Between the hauling machine 46 and the cut-off machine 47, a recess and protrusion sensor 49 is arranged, which is provided with a recess and protrusion detection probe 48 which is vertically moved along the recesses 28 and the protrusions 29 of the tubular portion 27 of the opening and closing member continuous body 37, and an output signal (e.g., a pulse signal) of the recess and protrusion sensor 49 is input to a controller 50. This controller 50 counts the number of the recesses 28 and/or the protrusions 29, based on the output signal of the recess and protrusion sensor 49. When the count value reaches a predetermined value, a driving signal is output to the cut-off machine 47, and the cut-off machine 47 is operated so as to cut the opening and closing member continuous body 37 into pieces, each piece corresponding to an individual opening and closing member.

In the cut-off machine 47, a cutting blade 51 is provided, which integrally arranges a blade which cuts the main body 23 of the opening and closing member continuous body 37 and a blade which cuts the projection portion 24 and the engagement portion 25 of the opening and closing member continuous body 37 at a position separate from the main body 23. Furthermore, it is also acceptable for a blade which cuts the main body 23 of the opening and closing member continuous body 37 to be arranged separately from a blade which cuts the projection portion 24 and the engagement portion 25 of the opening and closing member continuous body 37 at a position separate from the main body 23. With this cut-off machine 47, a processing in which the main body 23 of the opening and closing member continuous body 37 is cut to a predetermined horizontal direction dimension E (a horizontal direction dimension longer than horizontal direction dimension X of the handling hole 20) is performed simultaneously with a processing which cuts the projection portion 24 and the engagement portion 25 of the opening and closing member continuous body 37 to a predetermined horizontal direction dimension F (horizontal direction dimension which is not longer than the horizontal direction dimension X of the handling hole 20). By so doing, manufacturing of the opening and closing member is completed. Thus, by merely cutting the extruded opening and closing member continuous body 37, the opening and closing member 22 can be manufactured; thus, the opening and closing member 22 can be easily manufactured at a low cost.

Furthermore, if the recesses 28 and the protrusions 29 are not molded in the tubular portion 27 of the opening and closing member continuous body 37, when the tip end portion of the opening and closing member continuous body 37 is detected by a position sensor 52 (for example, an optical sensor constituted by a luminous element 52a and a photo detector 52b) arranged downstream from the cut-off machine 47 at a predetermined spacing, the cut-off machine 47 can be operated as the controller 50 outputs a drive signal to the cut-off machine 47.

Furthermore, it is not necessary to simultaneously perform a processing which cuts the main body 23 and a processing which cuts the projection portion 24 and the engagement portion 25. It is acceptable for the processing which cuts the main body 23 to be performed after the processing which cuts the projection portion 24 and the engagement portion 25. Alternatively, after the projection portion 24 and the engagement portion 25 are cut, the main body 23 can be cut.

According to this embodiment 1 explained above, by engaging the engagement portion 25 of the opening and closing member 22 with the flange 21 (upper edge flange portion 21a) formed at the periphery of the handling hole 20 of the container main body 11, the opening and closing member 22 is mounted to the container main body 11. Thus, the opening and closing member 22 can be easily mounted without adding special changes in shape, hole openings, or the like to the already-existing container main body 11 (the container main body 11 in which the flange 21 is formed at the periphery of the handling hole 20), adding changes into the container manufacturing device or manufacturing a new device. At the same time, when the opening and closing member 22 is not needed, the opening and closing member 22 can be easily removed.

Furthermore, if a user inserts his or her hand into the handling hole 20 of the container main body 11, the main body 23 of the opening and closing member 22 is pushed, and the handling hole 20 is uncovered. Thus, the user can insert his or her hand into the handling hole 20 and can hold the container main body 11, and the container main body 11 can be easily carried. Then, when the user removes his or her hand from the handling hole 20 of the container main body 11, the main body 23 of the opening and closing member 22 returns to the original position, and the handling hole 20 is covered. Thus, without performing a special operation or task, an undesired object (sand, dust, water drops, etc.) can be suppressed from entering the container main body 11 through the handling hole 20 during storage or transportation of the container main body 11, and quality of an article, etc. contained in the container main body 11 can be ensured.

Additionally, by covering the handling hole 20 with the main body 23 of the opening and closing member 22, even if an article is stored above the position of the handling hole 20 of the container main body 11, the article can be suppressed from falling outside of the container main body 11 through the handling hole 20. Thus, the article can be stored at a position above the handling hole 20 of the container main body 11. By so doing, the storage capacity per container can be increased compared to a conventional container, and storage and transportation spaces can be reduced.

Additionally, in this embodiment 1, the opening and closing member 22 is mounted so as to sandwich the flange 21 (the upper edge flange portion 21a) between the extension portion 26 and the engagement portion 25 of the opening and closing member 22. Therefore, the opening and closing member 22 can be mounted at an accurate position, and the engagement portion 25 can be suppressed from falling from the flange 21.

In addition, in this embodiment 1, a concave groove 34 is formed in the coupling portion 33, so the portion at which the concave groove 34 of the coupling portion 33 is formed becomes thinner so as to be easily bent. Thus, the opening and closing member 22 can be easily opened (moved inwardly). At the same time, other portions can be suppressed from deformation when the opening and closing member 22 is opened and closed (moved).

Furthermore, in this embodiment 1, a hollow tubular portion 27 is formed on the lower surface of the projection portion 24 of the opening and closing member 22. Thus, when the user inserts his or her hand into the handling hole 20, the contact feeling can be made soft when the user carries the tubular portion 27. Furthermore, the tubular portion 27 is formed in a substantially wave shape so that the recesses 28 and the protrusions 29 are alternatingly continuous. Thus, when the user inserts his or her hand into the handling hole 20 and holds the tubular portion 27, the fingers engage the recesses 28, and the user can stably hold the tubular portion 27.

In addition, in this embodiment 1, in the extrusion molding step, the ventilation grooves 35 are molded which extend continuously in a longitudinal direction on the lower surface of the projection portion 24 of the tubular portion 27. In the recess and protrusion molding step, the tubular portion 27 is molded in a substantially wave shape so that the hollow portions of each protrusion 29 of the tubular portion 27 are connected by the ventilation grooves 35 in the longitudinal direction. Thus, even after manufacturing of the opening and closing member 22 is completed, the hollow portions of the protrusions 29 of the tubular portion 27 are connected to each other by the ventilation grooves 35, and deformation of the protrusions 29 due to fluctuation of air pressure can be suppressed.

### Embodiment 2

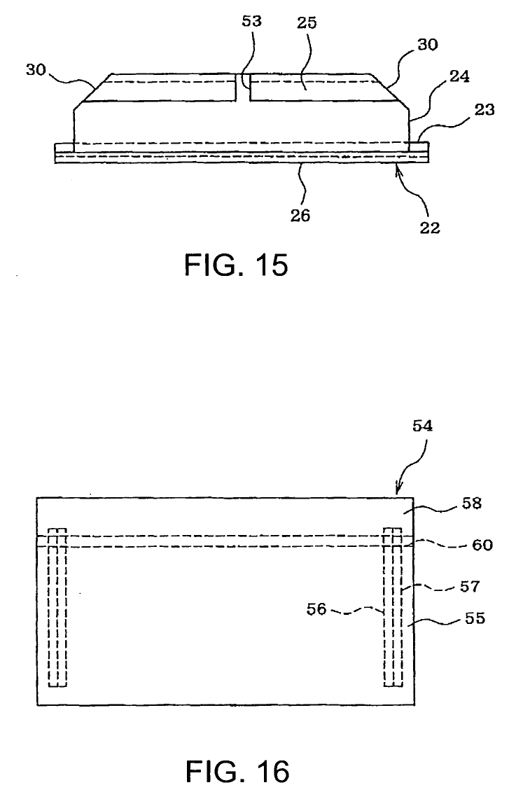

The following explains embodiment 2 of this invention with reference to FIGS. 14 and 15. The same symbols are used for the portions that are substantially the same as in the embodiment 1 in order to simplify the explanation. Mainly the portions that are different from the above-mentioned embodiment 1 will be explained.

In this embodiment 2, as shown in FIG. 14, with respect to the container main body 11, vertical reinforcement ribs 16 are formed on the outer surface center portion of the second side wall 14 as well. These vertical reinforcement ribs 16 are coupled to the center portion of the upper edge flange portion 21a and the lower edge flange portion 21b of the flange 21 in a direction perpendicular to the respective flange portions 21a, 21b. Furthermore, as shown in FIG. 15, in the opening and closing member 22, a slit 53 which can be engaged with one of the vertical reinforcement ribs 16 is formed in the center portion of the engagement portion 25 (position corresponding to one of the vertical reinforcement ribs 16). Other structures are the same as in the above-mentioned embodiment 1.

By so doing, even when vertical reinforcement ribs 16 are formed at the outer surface center portion of the second side walls 14 of the container main body 11, the engagement portion 25 of the opening and closing member 22 can be engaged to the flange 21 (upper edge flange portion 21a) without having the vertical reinforcement ribs 16 interfere. Furthermore, after engagement, position shifting in the horizontal direction is suppressed.

Furthermore, in the above-mentioned embodiments 1 and 2, by having the engagement portion 25 engaged to the upper edge flange portion 21a formed along the upper edge of the handling hole 20, the main body 23 of the opening and closing member 22 is constituted so as to be opened and closed about the upper edge side. However, instead of the above-mentioned structure, it is acceptable that by having the engagement portion 25 engaged to the lower edge flange portion 21b formed along the lower edge of the handling hole 20, the main body 23 of the opening and closing member 22 can be opened and closed about the lower edge side. Alternatively, it is also acceptable that by having the engagement portion 25 engaged to the side edge flange portion 21c formed along one side edge of the handling hole 20, the main body 23 of the opening and closing member 22 can be opened and closed about one side edge side.

Additionally, in the above-mentioned embodiments 1 and 2, only the coupling portion 33 and the engagement portion 25 of the opening and closing member 22 are formed from an elastic polymer material. However, it is also acceptable to form only the portions from the coupling portion 33 to the engagement portion 25 of the opening and closing member 22 (the coupling portion 33, the projection portion 24, the tubular portion 27, and the engagement portion 25) from an elastic polymer material, or to form the entire opening and closing member 22 from an elastic polymer material. If the entire opening and closing member 22 is formed from an elastic polymer material, the range in which elastic deformation is performed becomes larger compared to that of the above-mentioned embodiments 1 and 2, and local creep deformation can be suppressed from being generated in the coupling portion 33, etc. of the opening and closing member 22.

Furthermore, in the above-mentioned embodiments 1 and 2, the tubular portion 27 arranged at the lower side of the projection portion 24 is formed in a substantially wave shape, but it is also acceptable for the tubular portion 27 to be formed in a substantially straight line shape. Furthermore, it is also acceptable for the tubular portion 27 to be omitted.

### Embodiment 3

The following explains embodiment 3 of this invention with reference to FIGS. 16-18. The same symbols are used for the portions that are substantially the same as in the embodiment 1 in order to simplify the explanation. Mainly the portions that are different from the above-mentioned embodiment 1 will be explained.

In this embodiment 3, as shown in FIGS. 16-18, the opening and closing member 54 is integrally provided with a main body 55, vertical projection portions 56 protruding outward (in a direction perpendicular to the main body 55) from the main body 55 from both upper edge portions of the main body 55, engagement portions 57, which engage the flange 21, (side edge flange portion 21c in this embodiment 3) formed respectively at the tip end of the vertical projection portions, and an extension portion 58 extending in a direction substantially parallel to the main body 55 (direction extending upward) from the upper edge of the main body 55.

Each vertical projection portion 56 is formed so as to extend in a vertical direction along the side edge of the main body 55. However, only the upper end corner portions of the vertical projection portions 56 are coupled to the upper edge of the main body 55. Furthermore, in the coupling portion 59 of the main body 55 and the vertical protruding portions 56, a concave groove 60 may be formed, and the portion forming the concave groove 60 of the coupling portion 59 is thinner so as to allow easy bending.

The entire opening and closing member 54 can be formed from an elastic polymer material (polymer material of which hardness is smaller than that of the material of the container main body 11, and which is flexible, and is provided with an elastic recovery force), and a contact feeling becomes soft when the user inserts his or her hand into the handling hole 20 and touches the opening and closing member 54.

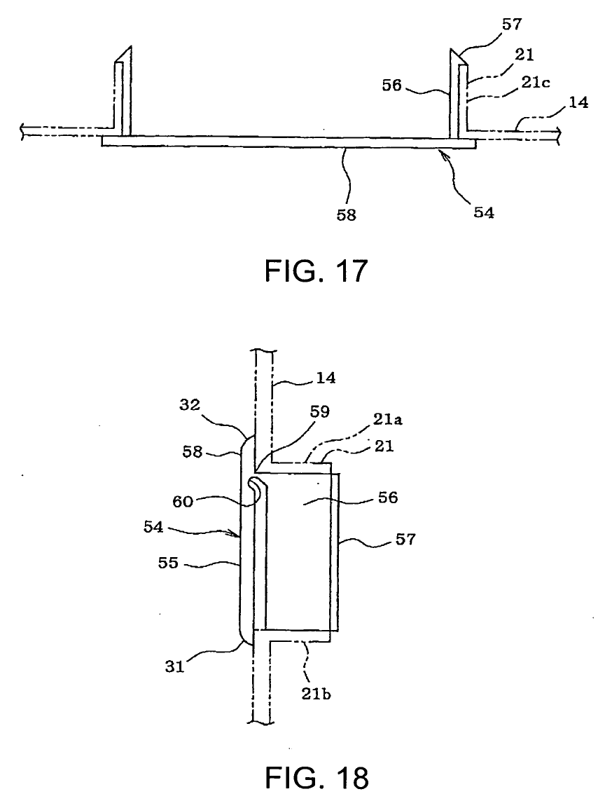

As shown in FIG. 17, in a state in which the main body 55 is arranged so as to cover the handling hole 20 from the inside of the container main body 11, by engaging the engagement portions 57 with the two side edge flange portions 21c formed along each side edge of the handling hole 20, the opening and closing member 54 can be simply mounted to the container main body 11, using the side edge flange portions 21c which reinforce the side edges of the handling hole 20.

In this embodiment 3 explained above, by having the opening and closing member 54 mounted to the container main body 11, the container main body 11 can be easily carried, using the handling hole 20 of the container main body 11. At the same time, an object can be suppressed from entering the container main body 11 through the handling hole 20.

Furthermore, in the above-mentioned embodiment 3, the entire opening and closing member 54 is formed from an elastic polymer material. However, it is also acceptable to form only the coupling portion 59 and the engagement portions 57 of the opening and closing member 54 by an elastic polymer material, or to form only the portions from the coupling portion 59 to the engagement portions 57 (the coupling portion 59, the vertical projection portions 56 and the engagement portions 57) of the opening and closing member by an elastic polymer material.

### Embodiment 4

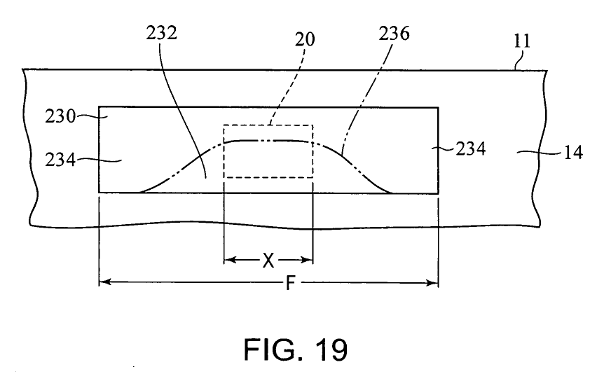

The following explains embodiment 4 of this invention with reference to FIG. 19. The same symbols are used for the portions that are substantially the same as in the embodiment 1 in order to simplify the explanation. Mainly the portions that are different from the above-mentioned embodiment 1 will be explained.

In this embodiment 4, the opening and closing member comprises a main body 230 that has a horizontal direction dimension F that is significantly longer, such as about three to five times longer, for example, than the horizontal direction dimension X of the handling hole 20. The opening and closing member may otherwise be formed with substantially the same structure as described above in connection with any of the above-mentioned embodiments 1-3. In this case, when the main body 230 is pushed by fingers inserted through the handling hole 20, the central portion 232 of the main body 230 is moved away from the handling hole, but the longitudinal ends 234 of the main body 230 may not move away from the handling hole. Rather, the main body 230 may bend along the line 236 shown in FIG. 19, such that the longitudinal ends 234 are in contact with the wall 14 while the central portion 232 is moved away from the handling hole 20. In the context of this application, “the main body moves” covers both a situation as shown in the previous embodiments, in which the entire main body moves, and the situation described in connection with FIG. 19, in which only a portion of the main body moves.

Furthermore, in the above-mentioned embodiments 1-4, a substantially square-shaped handling hole 20 is formed in the container main body 11, but the shape of the handling hole can be appropriately changed. For example, the shape of the handling hole can be formed in a substantially half-round shape, a substantially elongate shape, or a substantially elliptical shape.

Furthermore, this invention is not limited to a container molded in a box shape by injection molding or the like, but can also be applied to a container assembled into a box shape by folding a flat plate-shaped developed shape. Furthermore, instead of extrusion molding, the opening and closing member 54 can be molded by injection molding or compression molding, and various changes can be implemented within the scope of the claims.

As another example, although a container is described above that has handling holes in opposing side walls of a container, other container structures are possible that have only one handling hole, or more than two handling holes. For example, a single handling hole may be provide in a top wall of a container, and one of the above-described opening and closing members can be attached to the container at the handling hole. Also, it should be appreciated that the above-described opening and closing members can be applied to objects other than containers. For example, the opening and closing members may be applied to a wall of any hand-movable object that has a flanged hole formed therein.

What is claimed is:

1 An assembly comprising:
a wall in which a handling hole is formed;
a flange protruding outward from a periphery of the handling hole;
an opening and closing member including a main body with an external dimension that is larger than at least one of a horizontal direction dimension or a vertical direction dimension of the handling hole;
a projection portion protruding from an edge of the main body, the projection portion being sized to fit through the handling hole; and
an engagement portion, which engages the flange, and which extends from the projection portion, the engagement portion and a coupling portion that connects the main body and the projection portion being formed from an elastically deformable material;
the opening and closing member being arranged such that:
(i) the main body covers the handling hole from one side of the wall, the opening and closing member being mounted to the wall by engagement of the engagement portion with the flange,
(ii) when an external force acts on the main body through the handling hole, the main body moves and the handling hole is uncovered, and
(iii) when the external force is released, the main body elastically recovers and moves toward the wall, and part of the main body contacts the wall at the periphery of the handling hole so as to cover the handling hole.

2. The assembly as set forth in claim 1,
wherein the engagement portion of the opening and closing member engages an upper edge flange portion formed along an upper edge of the handling hole, and the main body of the opening and closing member moves by rotating about the upper edge.

3. The assembly as set forth in claim 1,
wherein the engagement portion of the opening and closing member engages a lower edge flange portion formed along a lower edge of the handling hole, and the main body of the opening and closing member moves by rotating about the lower edge.

4. The assembly as set forth in claim 1,
wherein the engagement portion of the opening and closing member engages a side edge flange portion formed along a side edge of the handling hole, and the main body of the opening and closing member moves by rotating about the side edge.

5. The assembly as set forth in claim 1,
wherein the movement of the main body is about the coupling portion.

6. The assembly as set forth in claim 5,
wherein a concave groove is formed in the coupling portion along a base end of the projection portion, such that the coupling portion is thinner at the concave groove than at a portion adjacent to the concave groove.

7. An opening and closing member mountable to a handling hole of a wall, the wall including a flange protruding outward from a periphery of the handling hole, the opening and closing member comprising:
a main body with an external dimension that is larger than at least one of a horizontal direction dimension or a vertical direction dimension of the handling hole;
a projection portion protruding from an edge of the main body, the projection portion being sized to fit through the handling hole; and
an engagement portion, which engages the flange, and which extends from the projection portion, the engagement portion and a coupling portion that connects the main body and the projection portion being formed from an elastically deformable material;
the opening and closing member being structured such that, in a state in which the main body is arranged so as to cover the handling hole from one side of the wall and is mounted to the wall by engagement of the engagement portion with the flange:
(i) when an external force acts on the main body through the handling hole, the main body moves and the handling hole is uncovered, and
(ii) when the external force is released, the main body elastically recovers and moves toward the wall, and part of the main body contacts the wall at the periphery of the handling hole so as to cover the handling hole.

8. The opening and closing member as set forth in claim 7,
wherein the projection portion is arranged so as to protrude outward from an upper or lower edge of the main body, and the engagement portion is formed in a folded-back shape so as to wrap around the flange.

9. The opening and closing member as set forth in claim 7,
wherein an extension portion is arranged which extends in a direction parallel to the main body from an upper or lower edge of the main body, and the extension portion is formed so as to contact a surface of the wall that is opposite to a surface from which the flange extends.

10. The opening and closing member as set forth in claim 7,
wherein in the engagement portion, a slit is formed which can engage a reinforcement rib formed in a direction crossing the flange.

11. The opening and closing member as set forth in claim 7,
wherein at least the coupling portion and the engagement portion are formed from an elastic polymer material which is flexible and provides an elastic recovery force.

12. The opening and closing member as set forth in claim 11,
wherein the elastic polymer material comprises rubber, synthetic resin, or thermoplastic elastomer.

13. The opening and closing member as set forth in claim 7,
wherein the entire opening and closing member is formed from an elastic polymer material which is flexible and provides an elastic recovery force.

14. The opening and closing member as set forth in claim 13,
wherein the elastic polymer material comprises rubber, synthetic resin, or thermoplastic elastomer.

15. The opening and closing member as set forth in claim 7,
wherein a concave groove is formed in the coupling portion along a base end of the projection portion, such that the coupling portion is thinner at the concave groove than at a portion adjacent to the concave groove.

16. The opening and closing member as set forth in claim 7,
wherein the projection portion protrudes from an upper edge of the main body, and on a lower surface of the projection portion, a hollow tubular portion is formed, which extends along the main body.

17. The opening and closing member as set forth in claim 16,
wherein the tubular portion is formed in a wave shape in which protrusions and recesses alternate in a direction along the main body.

18. The opening and closing member as set forth in claim 7,
wherein the main body is formed at an inclination so that, in a state prior to mounting the opening and closing member to the handling hole, a lower edge of the main body protrudes farther than an upper edge of the main body, in a direction parallel to the projection portion.

19. The opening and closing member as set forth in claim 7,
wherein the movement of the main body is about the coupling portion.

20. The opening and closing member as set forth in claim 19,
wherein a concave groove is formed in the coupling portion along a base end of the projection portion, such that the coupling portion is thinner at the concave groove than at a portion adjacent to the concave groove.

21. A method for manufacturing an opening and closing member mountable to a handling hole formed in a wall, the wall including a flange protruding outward from a periphery of the handling hole, the method comprising:
preparing an elongate opening and closing member continuous body, which is continuous in a longitudinal direction, and in which a main body, a projection portion protruding from an upper or lower edge of the main body, and an engagement portion which extends from the projection portion, and which engages the flange, are integrally arranged, and in which at least (i) a coupling portion that couples the main body and the projection portion and (ii) the engagement portion are formed from an elastically deformable material;
cutting the main body of the opening and closing member continuous body to a predetermined horizontal direction dimension; and
cutting the projection portion and the engagement portion of the opening and closing member continuous body to a horizontal direction dimension not longer than the horizontal direction dimension of the handling hole,
wherein the main body is formed such that an outer dimension of the main body is larger than at least one of a horizontal dimension of the handling hole or a vertical dimension of the handling hole.

22. The method for manufacturing an opening and closing member as set forth in claim 21,
wherein the continuous body preparation step is an extruding step which extrudes the opening and closing member continuous body in a constant horizontal cross-section shape from a polymer material.

23. The method for manufacturing an opening and closing member as set forth in claim 22,
wherein in the extruding step, at least the coupling portion and the engagement portion are molded from an elastically deformable polymer material.

24. The method for manufacturing an opening and closing member as set forth in claim 23,
wherein in the extruding step, the entire opening and closing member continuous body is molded from an elastically deformable polymer material of which a hardness is smaller than that of a material of the wall.

25. The method for manufacturing an opening and closing member as set forth in claim 21,
wherein in the extruding step, a hollow tubular portion is integrally molded, which extends continuously in a longitudinal direction at a lower surface of the projection portion.

26. The method for manufacturing an opening and closing member as set forth in claim 25,
wherein a pushing roller is used, in which protrusions and recesses alternate along an outer circumferential portion; and
a protrusion and recess molding step is included in which after the extruding step, in a state in which the outer circumferential portion of the pushing roller is pushed against the lower surface of the tubular portion, by rotating the pushing roller in synchronization with an extruding speed, the tubular portion is molded in a wave shape in which protrusions and recesses alternate along a longitudinal direction.

27. The method for manufacturing an opening and closing member as set forth in claim 26,
wherein an outer circumferential length of the pushing roller is an integer multiple of the horizontal direction dimension of the main body.

28. The method for manufacturing an opening and closing member as set forth in claim 26,
wherein on the pushing roller, at least one protrusion is formed whose circumferential length is different from that of other protrusions.

29. The method for manufacturing an opening and closing member as set forth in claim 26,
wherein in the extruding step, a ventilation groove is molded in the lower surface of the projection portion, and extends continuously in a longitudinal direction of the tubular portion, and
in the recess and protrusion molding step, the tubular portion is molded into a wave shape, and hollow portions of the protrusions of the tubular portion are connected to each other by the ventilation groove.
